(19) United States
(12) Patent Application Publication
(10) Pub. No.: US 2022/0325678 A1
(43) Pub. Date: Oct. 13, 2022

(54) LOBED MIXER NOZZLES FOR SUPERSONIC AND SUBSONIC AIRCRAFT, AND ASSOCIATED SYSTEMS AND METHODS

(71) Applicant: BOOM TECHNOLOGY, INC., Centennial, CO (US)

(72) Inventors: Vinod G. Mengle, Foothill Ranch, CA (US); Cory Hodgkins, Tyner, KY (US); Vikram Aditya Kumar, Denver, CO (US)

(21) Appl. No.: 17/715,450

(22) Filed: Apr. 7, 2022

Related U.S. Application Data
(60) Provisional application No. 63/172,507, filed on Apr. 8, 2021.

(51) Int. Cl. F02K 1/46; B64C 30/00; F02K 1/34; B64C 1/06

(52) U.S. Cl. CPC F02K 1/46; B64C 30/00; B64D 33/06; B64C 1/061; F05D 2220/80; F05D 2260/96

(57) ABSTRACT

Lobed mixer nozzles for supersonic and subsonic aircraft, and associated systems and methods are disclosed herein. A representative lobe mixer nozzle includes a fan flow duct aligned along a longitudinal axis, and a core flow duct, also aligned along the longitudinal axis. At least one duct wall, for example, a splitter, forms, at least in part, a radially inner boundary of the fan flow duct, and a radially outer boundary of the core flow duct. The duct wall terminates at a reference exit plane, and has multiple first lobes extending radially inwardly, and multiple second lobes extending radially outwardly. At least one lobe is canted forward relative to the reference exit plane, and at least one lobe is canted aft relative to the reference exit plane.

### CROSS-REFERENCE TO RELATED APPLICATION

The present application claims priority to pending U.S. Provisional application 63/172,507, filed on Apr. 8, 2021 and incorporated herein by reference.

### TECHNICAL FIELD

The present technology is directed generally to lobed mixer nozzles for supersonic and subsonic aircraft, and associated systems and methods.

### BACKGROUND

Supersonic aircraft have been used primarily for military missions since the mid-1950s. Then, in the 1970s, the United States and Europe each developed commercial supersonic aircraft: the supersonic transport, or “SST” in the United States, and the Concorde in Europe. The Concorde went on to fly commercial passengers on transatlantic routes through the 1990s. The fleet was permanently retired in 2003, following a temporary grounding in 2000 resulting from an accident. Despite the fact that the Concorde flew commercial passengers for several decades, it was not generally considered a commercially successful program because high operating costs did not make it broadly viable. Another drawback with the Concorde, and with supersonic aircraft generally is the amount of noise they generate, especially at take-off, when they incur noise penalties. Accordingly, and in light of the Concorde's retirement, there remains a need in the industry for a viable and profitable supersonic commercial aircraft which can also satisfy the more stringent noise limits during take-off and yet be thrust-efficient.

Both supersonic and subsonic aircraft take off at subsonic speeds, and any approaches to reduce jet noise applied to supersonic aircraft can, generally, also be applied to subsonic aircraft if the overall engine architecture is similar. One method for reducing the noise produced by turbofan engines is to use long-ducted mixed-flow nozzles wherein the hot core flow and the relatively cooler fan flow are mixed inside the nozzle to achieve a more uniform flow near the nozzle exit. More uniform flow reduces jet noise and can increase the thermodynamic efficiency of the engine. The technology disclosed herein deals with enhancing the mixing between the core and the fan flow even further than existing systems do, to increase jet noise reduction and thrust efficiency.

### BRIEF DESCRIPTION OF THE DRAWINGS

FIG. 1 is a partially schematic, side view illustration of an aircraft having a propulsion system configured in accordance with embodiments of the present technology.

FIG. 2 is a partially schematic, cut-away side view illustration of a propulsion system having a mixer configured in accordance with embodiments of the present technology.

FIG. 3 is an enlarged, side view illustration of an embodiment of the mixer shown in FIG. 2.

FIGS. 4A and 4B are side view illustrations of forward- and backward- or aft-canted mixer lobes configured in accordance with embodiments of the present technology.

FIGS. 5A-5C illustrate a three-dimensional model of a representative mixer from the side (FIG. 5A), from below (FIG. 5B), and from an upstream or forward point of view (FIG. 5C) configured in accordance with embodiments of the present technology.

FIG. 6A illustrates a representative mixer, looking forward from a position aft of the mixer, in accordance with embodiments of the present technology.

FIG. 6B is an enlarged view of a portion of the mixer shown in FIG. 6A.

FIG. 7 is a table comparing cruise thrust coefficients for mixers having multiple configurations, including configurations in accordance with the present technology.

FIGS. 8A-8C compare axial vorticity distribution at the nozzle exit plane for nozzles having forward-canted lobes (FIG. 8A), backward-canted lobes (FIG. 8B), and alternate forward- and backward-canted lobes (FIG. 8C).

FIGS. 9A and 9B compare the axial evolution of circulation around different half-lobe edges for mixer configurations having uncanted mixer lobes, alternating canted mixer lobes and backward-canted mixer lobes (FIG. 9A, element 142b) or forward-canted mixer lobes (FIG. 9B, element 142a).

FIGS. 10A-10C illustrate total temperature contours at the nozzle exit plane for mixer nozzles having forward-canted mixer lobes (FIG. 10A), backward-canted mixer lobes (FIG. 10B), and alternating backward- and forward-canted mixer lobes (FIG. 10C).

FIG. 11 compares the axial evolution of total temperature mixing between the nozzles having uncanted mixer lobes, backward-canted mixer lobes, forward-canted mixer lobes, and alternating backward- and forward-canted mixer lobes.

FIG. 12 is a partially schematic side view illustration of a nozzle having a convergent-divergent duct and a mixer configured in accordance with embodiments of the present technology.

FIG. 13 a partially schematic side view illustration of a mixer having forward- and backward- or aft-canted lobes with equal heights, in accordance with embodiments of the present technology.

### DETAILED DESCRIPTION

The present technology is directed generally to mixer nozzles for supersonic and subsonic aircraft, and associated systems and methods. The mixer is a series of lobes or chutes around the periphery, typically, of a center-cone inside the nozzle, and is formed of corrugations with valleys and peaks which alternately carry the fan flow and the core flow. In particular embodiments, the mixer nozzles include an alternating pattern of lobes, with forwardly-canted lobes alternating with backwardly- or aft-canted lobes. This approach can be applied to the core flow lobes, as is illustrated in several of the Figures below, and/or the fan flow lobes. Several of the embodiments are described below with reference to a supersonic propulsion system with subsonic flow in the mixer region. However, in other embodiments, similar techniques can also be applied to subsonic aircraft propulsion systems with subsonic flow in the mixer region. In any of these embodiments, it is expected that the alternating pattern of cant angle(s) in the mixer lobes can further improve mixing between the core flow and fan flow streams of the propulsion system, thereby reducing noise when compared with conventional nozzles. It is further expected that the noise reductions will be produced without significant decreases in the relevant thrust parameters, and, in fact, increases in the thrust metrics, by which the propulsion system is typically benchmarked or evaluated.

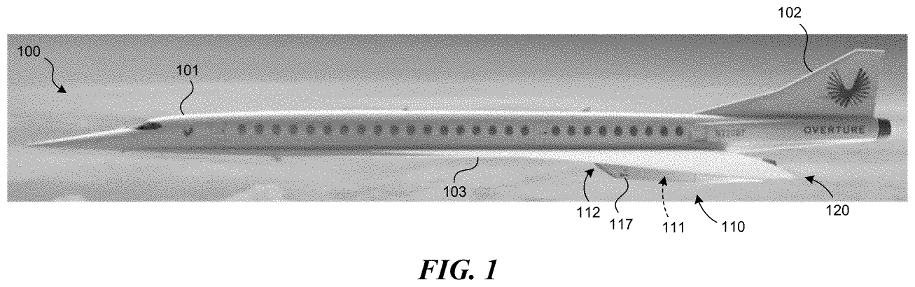

Specific details of several embodiments of the technology are described below with reference to selected configurations to provide a thorough understanding of these embodiments, with the understanding that the technology may be practiced in the context of other embodiments. Several details describing structures or processes that are well-known and often associated with other types of supersonic or subsonic aircraft and/or associated systems and components, but that may unnecessarily obscure some of the significant aspects of the present disclosure, are not set forth in the following description for purposes of clarity. Moreover, although the following disclosure sets forth several embodiments of different aspects of the technology, several other embodiments of the technology can have configurations and/or components that differ from those described in this section. As such, the technology may have other embodiments with additional elements and/or without several of the elements described below with reference to FIGS. 1-13.

FIG. 1 is a partially schematic, side view illustration of a supersonic aircraft 100 configured in accordance with embodiments of the present technology. The aircraft 100 can include a fuselage 101, wings 103, and a vertical stabilizer 102, along with other flight control surfaces not illustrated in FIG. 1 for purposes of simplicity. The aircraft 100 further includes a propulsion system 110, which in turn can include one or more nacelles 117, for example, one nacelle 117 carried by each wing 103. Each nacelle 117 includes an inlet 112, which provides air to an engine 111. A nozzle 120 directs engine exhaust products and bypass fan flow in an aft direction to provide thrust to the aircraft 100.

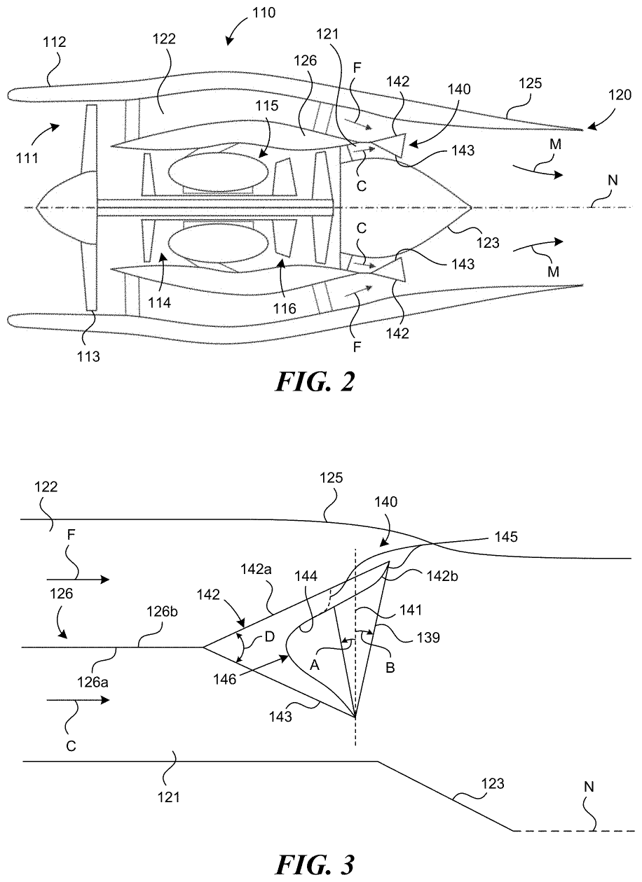

FIG. 2 is a partially schematic and simplified, cut-away view of a representative propulsion system 110 configured in accordance with embodiments of the present technology. FIG. 2 illustrates the inlet 112, the engine 111, and the nozzle 120. The nozzle 120 includes an outer wall 125 between the external airstream and the internal gas flow. The engine 111 includes a fan 113, a single- or multi-stage compressor 114, a combustor 115, and a single- or multi-stage turbine 116. The turbine 116 drives the compressor 114 and the fan 113. The fan 113 drives a bypass or fan flow F through a fan flow duct 122 and around the core of the engine 111, while the exhaust products from the turbine 116 (e.g., a core flow C) are directed through a core flow duct 121.

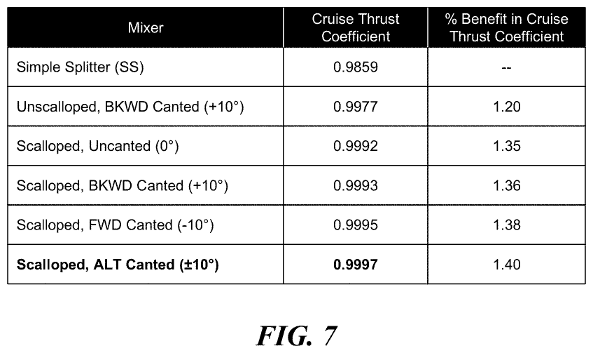

The propulsion system 110 further includes a mixer 140 that receives the core flow C and the fan flow F, and mixes the two flows to produce a mixed flow M which is directed aft around a center-cone 123 and out of the nozzle 120, generally along a nozzle axis N (e.g., a longitudinal axis). The mixer 140 can include multiple lobes that are shaped, positioned, oriented, and/or sized to match the desired mass-flowrate from the engine and improve the mixing between the relatively cool, low-speed fan flow F, and the relatively hot, high-speed core flow C. Accordingly, the mixer 140 can include multiple core lobes 142 that direct a portion of the core flow from the core flow duct 121 radially outwardly to mix with the fan flow F. The lobes can further include multiple fan lobes 143 that direct a portion of the fan flow F radially inwardly to mix with the core flow C. Further details of the configurations for the mixer lobes are described below with reference to FIGS. 3-6B and 13. Analytical results predicting the beneficial effects of these configurations are described further below with reference to FIGS. 7-11.

FIG. 3 is an enlarged, partially schematic illustration of a portion of the mixer 140 shown in FIG. 2. As shown in FIG. 3, the core flow C in the core flow duct 121 is bounded radially inwardly by the center-cone 123, and radially outwardly by an inwardly-facing side 126a of a duct wall or splitter 126. The fan flow F, flowing in the fan flow duct 122, is bounded inwardly by the outwardly-facing side 126b of the duct wall 126, and outwardly by the outer wall 125 of the nozzle 120. As described above, the fan lobes 143 direct a portion of the fan flow F into the core flow duct 121, and the core lobes 142 direct a portion of the core flow C into the fan flow duct 122. The lobes 142, 143 extend in a downstream direction from the intermediately-positioned duct wall 126, with an inward radial component for the fan lobes 143, and an outward radial component for the core lobes 142.

The lobes 142, 143 are generally shaped to provide improved mixing and noise reduction, without a significant adverse effect on thrust, and in fact, a positive effect on thrust in at least some embodiments. If the mixing is too strong then it generates high turbulent kinetic energy inside the nozzle, which creates high frequency noise in the far field, and also creates total pressure losses; on the other hand, strong mixing can create a more uniform flow at the nozzle exit which lowers low-frequency noise, while also improving thermodynamic thrust-efficiency. Hence, embodiments of the present technology balance the amount of enhanced mixing introduced inside the nozzle through the lobed mixers.

Streamwise or axial vorticity ingested into the main flow stream enhances the mixing between the core flow and the fan flow, and the lobe shapes are designed to tailor this ingested axial vorticity. Each lobe is bounded at its aft end by a lobe edge 144. The lobe edge 144 can include a “scalloped” portion 146, e.g., a portion that is cut out in the lobe sidewalls in a forward direction relative to a mixer reference plane 141. For reference, FIG. 3 also illustrates a “non-scalloped” portion 139. The scalloped portions 146 can be selected to further tailor the axial vorticity generated and enhance the mixing between the fan and the core flows compared to the non-scalloped lobes. In general, the reference plane 141 is perpendicular to the nozzle axis N (e.g., the centerline of an axisymmetric nozzle). The lobe edge 144 can also include a trailing edge portion 145, which defines the aft-most edge of the lobe. As shown in FIG. 3, the crown lines of the core lobes 142 can extend in an aft direction by different amounts than do the keel lines of the fan lobes 143. For example, the core lobes 142 can include a first core lobe 142a having a trailing edge 145 (shown in dotted lines) that is canted forward relative to the reference plane 141 by an angle A. The core lobes 142 can further include second core lobes 142b having a trailing edge 145 (shown in solid lines) that is canted aft or backward relative to the reference plane 141, as indicated by angle B. In particular embodiments, the mixer 140 includes an alternating arrangement of first core lobes 142a and second core lobes 142b that enhance mixing in a thrust-efficient manner, when compared to mixers having other, non-alternating cant angle configurations.

The terms “forward” and “backward” (or “aft”), when used herein in the context of describing the cant of the lobes, are used with reference to the aircraft engine, in which the inlet is “forward” and the nozzle is “backward.” In some of the existing literature describing lobe cant angles, the frame of reference is the aft-flowing direction of the combustion products—in which case “forward” and “backward” have the opposite sense.

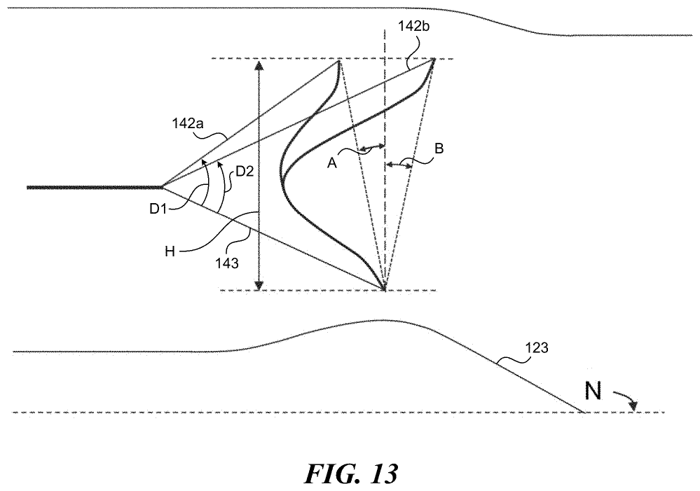

In the arrangement shown in FIG. 3, both the first and second core lobes 142a, 142b diverge from the corresponding fan lobes 143 by the same divergence angle D. In other embodiments (for example, as describe below with reference to FIG. 13), the first and second core lobes 142a, 142b can diverge at different angles.

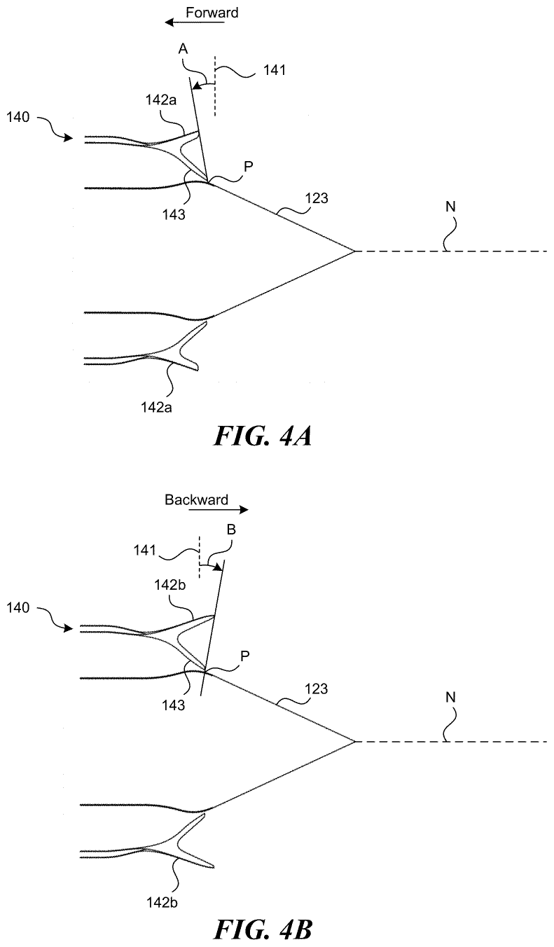

FIGS. 4A and 4B are simplified versions of a portion of the mixer 140 shown in FIG. 3, and further illustrate the forward- and aft-cant arrangements of the core lobes 142. FIG. 4A illustrates two first core lobes 142a, canted forward by a first angle A relative to the reference plane 141. FIG. 4B illustrates two second core lobes 142b, canted aft by a second angle B relative to the reference plane 141. In FIGS. 4A and 4B, the pivot point P about which the cant angle is measured is at (or approximately at) the aft tip of the fan lobe 143. In other embodiments, the pivot point can have other radial locations.

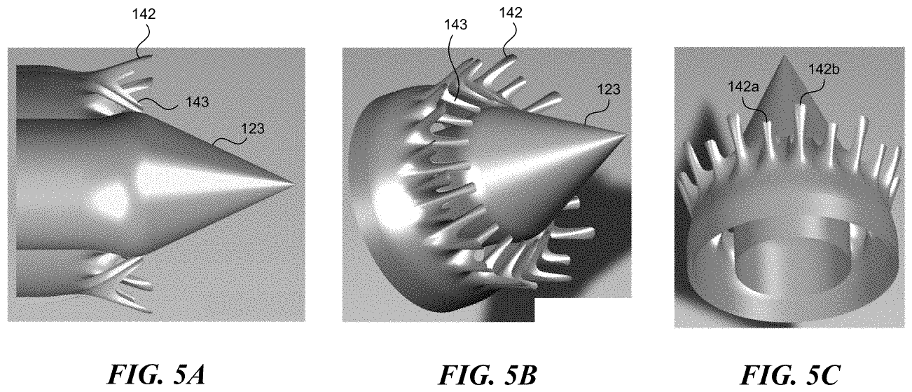

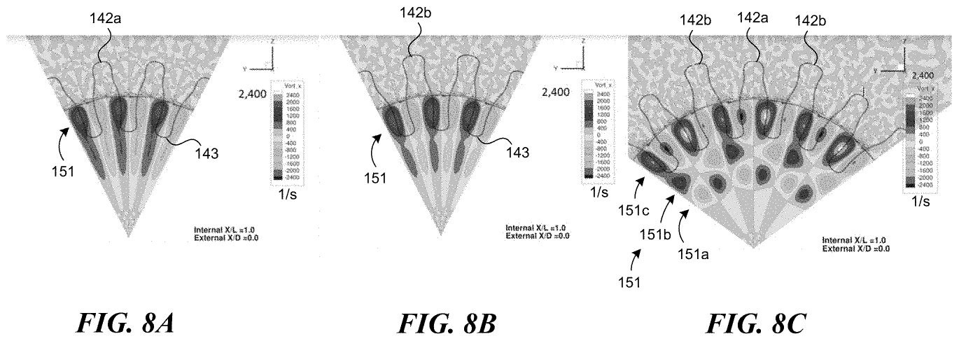

FIGS. 5A-5C illustrate multiple views of a representative mixer 140 having uniformly-sized fan lobes 143, and core lobes 142a, 142b that alternate between forward-canted and aft-canted. As is best seen in FIG. 5C, the first core lobes 142a, which are canted forward, are shorter than the second core lobes 142b, which are canted aft. Because both the core lobes 142 and the fan lobes 143 transfer flow in opposite radial directions, the axial vorticity thus generated enhances the mixing orthogonal to the radial shear layers, that is, mixing enhances in the circumferential direction. In addition, since the lobes are alternately canted in the forward and backward direction the axial vorticity is radially distributed downstream or aft of the mixer in such a manner that the mixing is enhanced also in the radial direction. This latter feature is a unique feature of the alternately canted lobe mixers, not present in other lobed mixers which are not alternately canted, and is also shown later in FIG. 8C, and described there in more detail.

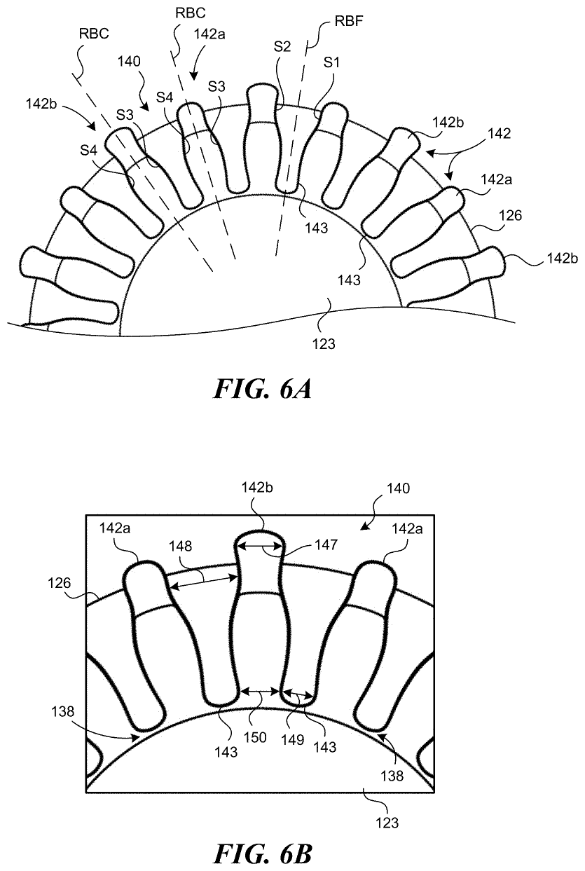

FIG. 6A is a view of a representative mixer 140, looking forward from behind the mixer. Accordingly, FIG. 6A illustrates the center-cone 123, the duct wall 126 separating the core flow from the fan flow, and the alternating arrangement of first core lobes 142a and second core lobes 142b. Neighboring core lobes 142 are separated from each other by fan lobes 143, for example, a single fan lobe 143 between a first core lobe 142a and a second core lobe 142b. Note that each fan lobe 143 shares its lobe sidewalls S1 and S2 with the neighboring core lobes 142a and 142b, and the two corners of the fan lobes 143 are also shared with the corners of the neighboring core lobes 142a and 142b.

Because the fan lobes alternate between forward canted first core lobes 142a and aft canted second core lobes 142b, the intermediate fan lobe 143 is asymmetric about its corresponding bisecting radial plane RBF. In particular, opposing sides S1, S2 of the fan lobe 143 are asymmetric relative to the corresponding bisecting radial plane RBF. Conversely, each core lobe, whether a first core lobe 142a or a second core lobe 142b, is positioned between two fan lobes 143, which are mirror-symmetric about the radially bisecting plane RBC between them. Accordingly, the opposing sides S3, S4 of the core lobes 142a, 142b are symmetric relative to the respective corresponding bisecting radial planes RBC. In another embodiment for which the fan lobes alternately cant forward and backward, and the core lobes do not, the opposite is true.

FIG. 6B is an enlarged view of the mixer 140 shown in FIG. 6A. The core lobes 142a, 142b can have a core lobe width 147, and can be separated from each other by a core lobe spacing or separation distance 148. The fan lobes 143 can have a fan flow width 149, and can be separated from each other by a fan flow spacing or separation distance 150. The values selected for the widths 147, 149 and the spacings 148, 150 (which depend on the total number of core and fan lobes around the periphery of the mixer 140), can be selected to improve mixing and/or noise characteristics, and/or to improve (e.g., simplify) the process for manufacturing the mixer 140. In a representative embodiment, the core lobe spacing distances 148 are uniform around the circumference of the center-cone 123. In other embodiments, the core lobe spacing distance 148 can vary around the circumference. Similarly, the fan lobe width 149 and/or the fan lobe separation distance 150 can be uniform, or can vary, around the circumference of the center-cone 123. Further, the core lobe width 147 can be the same or generally the same for both first and second core lobes 142a, 142b. In other embodiments, these widths can be different, depending, for example, on whether the lobe is canted forward, or canted backward, and/or other factors.

As shown in FIG. 6B, a gap 138 exists between the radially inward-most edge of the fan lobes 143 and the surface of the center-cone 123 at that axial station. The gap 138 is typically very small relative to the lobe “heights” (e.g., radial extents), and, in a particular embodiment, all fan lobe inner-most edges are equidistant from the center-cone surface 123, so that better mixing is achieved between the hot core flow and the cooler fan flow downstream of the center-cone 123. Having a larger fan lobe width 149, comparable to the core lobe width 150, also facilitates quick mixing between the two flows with generation of additional axial vorticity near the lobe inner-most surfaces, close to the center-cone surface 123.

FIG. 7 illustrates a table comparing the cruise thrust coefficients of mixers having a variety of different arrangements, including an alternating lobe arrangement in accordance with an embodiment of the present technology. As shown in FIG. 7, a simple splitter or duct wall, e.g., a splitter with no lobes, provides a baseline cruise thrust coefficient of 0.9859. When unscalloped, backward-canted lobes are added, the thrust coefficient increases to 0.9977. If these lobes are replaced with scalloped, uncanted lobes, the thrust coefficient increases to 0.9992. Scalloped backward-canted lobes produce a thrust coefficient of 0.9993, and scalloped forward-canted lobes produce a thrust coefficient of 0.9995. The last column in FIG. 7 also shows the % benefit in this cruise thrust coefficient for the different lobe mixers compared to the simple splitter.

Although one might expect scalloped lobes that alternate between forward- and backward-canted configurations would produce a thrust coefficient in between that of forward-canted lobes and backward-canted lobes (e.g., a value of 0.9994), they instead produce a thrust coefficient greater than either a backward-canted configuration or a forward-canted configuration. In particular, based on computational fluid dynamic simulations, an arrangement of alternating backward- and forward-canted core lobes produces a cruise thrust coefficient of 0.9997. While this value may appear at first blush to be only a marginal increase over the thrust coefficient associated with forward-canted and backward-canted lobes alone, the effect is more significant. In particular, (a) even what appears to be an incremental increase can still be a significant improvement over the life of the engine and associated aircraft, and (b) it is expected that the increased mixing will reduce or otherwise improve the acoustic signature of the aircraft, while also improving thrust coefficient and thrust specific fuel consumption (TSFC). In particular, the improvement in cruise TSFC is, typically, three to four times the improvement in cruise thrust coefficient; hence, even incremental differences in the thrust coefficient amplify the benefit for fuel consumption. Further details of parameters that are expected to improve acoustic performance are described below.

FIGS. 8A-8C compare predicted axial vorticity at the exit of a nozzle, which is downstream of a mixer. Representative mixers having configurations generally similar to those described above are compared in FIGS. 8A-8C. The darker and lighter shades typically represent axial vorticity of opposite directions, one clockwise and the other counter-clockwise. FIG. 8A illustrates predicted axial vorticity 151 associated with a mixer having only first core lobes 142a, e.g., only core lobes that are canted in a forward direction. FIG. 8B illustrates predicted axial vorticity for a mixer having only second core lobes 142b, e.g., only core lobes that are canted in an aft or backward direction. FIG. 8C illustrates vortices 151 for a configuration that includes a mixer having both first (forward-canted) and second (aft-canted) core lobes 142a, 142b. As shown in FIGS. 8A and 8B, the vortices 151 have an overall elongated configuration, due to merging of vortices of the same direction. The radially outer layer contains the main vortices generated by the scallops in the lobe sidewalls. Referring briefly to FIG. 6B, the radially inner layer of vortices are generated at the radially inward corners of the fan lobes 143 in the gap 138 between the lobes and the center-cone surface 123 due to the radially inward flowing fan flow displacing the radially outward flowing core flow, and will be referred to here as “gap vortices”.

By contrast, and as shown in FIG. 8C, the combination of first and second core lobes 142a, 142b is predicted to produce three layers or sets of axial vortices: a set of radially inner vortices 151a, a set of middle vortices 151b, and a set of radially outer vortices 151c. The outer axial vortices 151c are expected to form primarily due to the scallops in the lobes, as in FIGS. 8A and 8B, and the middle and inner axial vortices 151b, 151a are produced in the gap between the lobes and the center-cone, described above with reference to FIGS. 8A, 8B and 6B. The middle layer 151b is generated at the radially inward corners of the backward canted core lobes 142b, and the inner layer 151a is generated at the radially inward corners of the forward canted core lobes 142a. It is further expected that these two sets of gap vortices get separated radially due to the alternate canting of the lobes, as shown in FIG. 8C, thus enhancing radial mixing. Those vortices with the same rotational direction are expected to finally merge together downstream from the nozzle exit plane to form larger vortices which further enhance mixing downstream due to large-scale stirring action.

The foregoing difference in flow phenomena is expected to produce a lower, or at least different, acoustic signature than that produced by the configurations shown in FIGS. 8A and 8B. For example, it is expected that the increased number of small vortices may reduce the low frequency component of the nozzle noise signature due to better overall mixing further downstream, while only marginally increasing the high frequency component, if at all. As a result, it is expected that the acoustic impact of the aircraft on the people below the aircraft can be noticeably reduced. For example, reducing or changing the acoustic signature is particularly important at low altitude, maximum thrust conditions, for example, during takeoff.

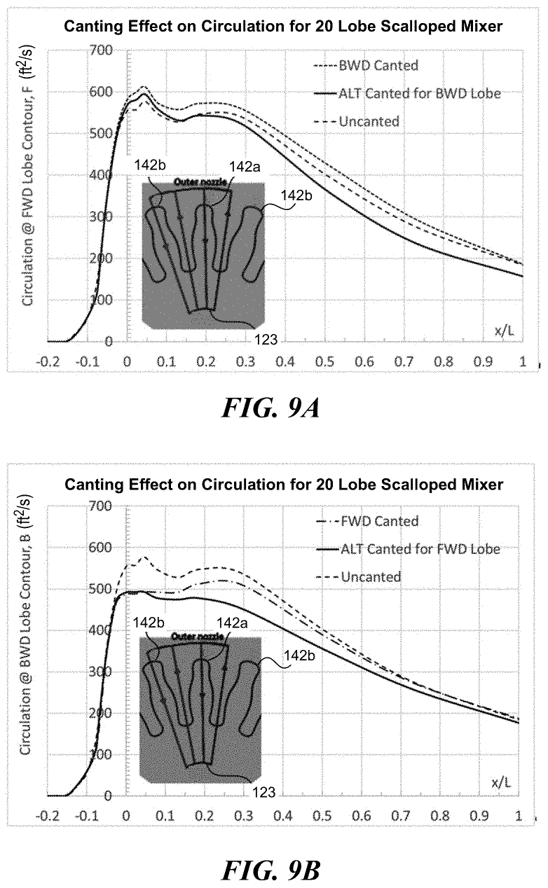

FIG. 9A compares the predicted circulation levels for a mixer having only backward (BWD)-canted lobes, with mixers having uncanted lobes, around a closed contour surrounding one lobe sidewall in each mixer, and with a mixer having alternating backward- and forward-canted lobes around a closed contour surrounding its one lobe sidewall 142b which is backward canted. The x-axis represents the non-dimensionalized length of the mixer, with X/L=0 corresponding to the mixer exit plane and X/L=1 corresponding to the nozzle exit plane. As shown in FIG. 9A, the alternating lobe configuration reaches almost the same peak circulation value as the backward canted or the uncanted lobes close to the mixer exit plane (X/L of about 0.05), but then, through most of the nozzle length, it has lower circulation values than those two mixers. An increased circulation peak near the mixer exit plane helps accelerate mixing deep inside the nozzle, where it can be relatively well-shielded in terms of high-frequency noise radiating to the far field outside the nozzle. On the other hand, reduced circulation is expected to result in gentler mixing further downstream, and therefore less high frequency noise. Accordingly, in addition to reducing low frequency noise, as discussed above, this configuration is expected to reduce high frequency noise as well. FIG. 9B shows similar results when comparing the circulation for alternating forward- and backward-canted lobes around a closed contour surrounding its one lobe sidewall 142a which is forward canted, to that of forward-canted lobes only, and uncanted lobes. In particular, the alternating pattern reduced circulation compared to both uncanted lobes and forward-only canted lobes, although the peak is similar to the forward-canted lobes only.

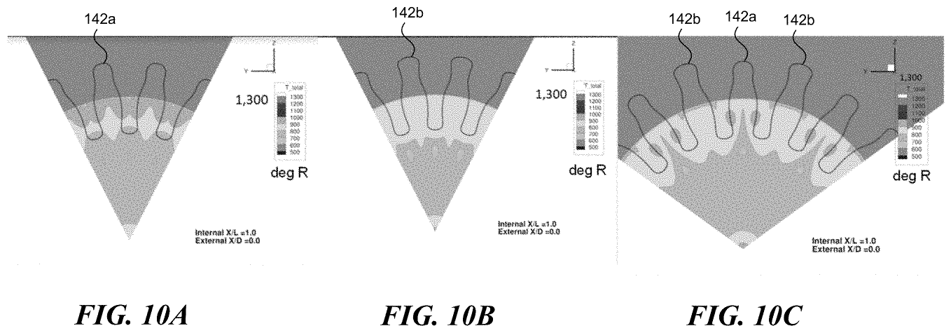

FIGS. 10A-10C illustrate predicted total or stagnation temperature contours at the nozzle exit plane (Internal X/L=1.0) for a mixer having forward-canted lobes 142a (FIG. 10A), backward-canted lobes 142b (FIG. 10B) and alternating forward- and aft-canted lobes 142a, 142b (FIG. 10C). The temperature contours indicate generally that the alternating lobes provide a level of temperature mixing that is between that associated with forward-canted lobes and backward-canted lobes, but is closer to the contours associated with backward-canted lobes 142b. The backward-canted lobes are expected to produce a lower level of “hot-spot” or temperature-related dipole-type noise source(s).

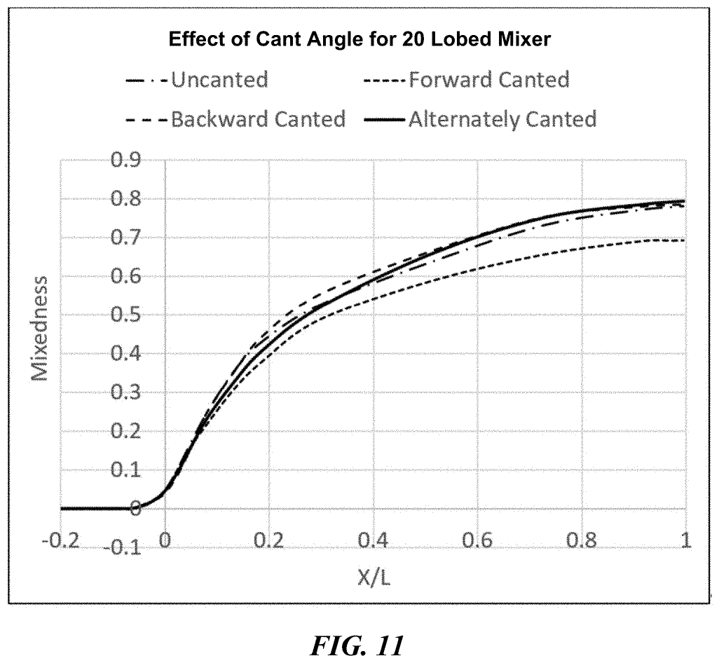

FIG. 11 further illustrates quantitatively the expected total temperature mixing of the differently canted lobes via a scalar “Mixedness” metric inside the nozzle from the mixer exit plane (X/L=0) to the nozzle exit plane (X/L=1). This Mixedness metric shows the normalized deviation of integrated mass-flowrate weighted total temperature at an axial station from an ideal fully-mixed flow total temperature. A Mixedness value of 0 corresponds to an unmixed flow, and a Mixedness value of 1 corresponds to a fully-mixed flow. FIG. 11 compares the mixing between the uncanted lobes, the forward canted lobes, the backward canted lobes, and the alternately forward and backward-canted lobes. FIG. 11 shows that the alternately-canted lobes have the highest mixedness value, almost 80% of fully-mixed, and slightly higher than the backward-canted lobes. Accordingly, the overall performance of the alternating canted lobe configuration when accounting for low frequency noise, high frequency noise, and thrust performance, is predicted to be better than the overall performance associated with either forward-canted lobes alone, or backward-canted lobes alone, or uncanted lobes.

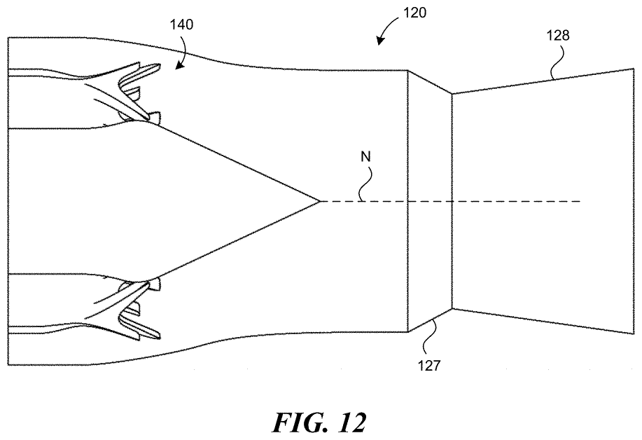

As discussed above, embodiments of the present technology can provide one or more advantages when compared with conventional mixer nozzles. In particular, embodiments of the present technology can reduce the amplitude of the nozzle acoustic signature, and/or change the frequency spectrum of the acoustic signature to reduce the overall impact of the nozzle on the environment over which the associated aircraft flies during take-off. As discussed above, the foregoing improvements in acoustic performance at take-off can be accompanied by an overall improvement in the cruise thrust coefficient, in at least some embodiments. Embodiments of the technology described above were described in the context of a supersonic aircraft having a convergent nozzle duct and subsonic flow near the lobe mixers. In other embodiments, for example as shown in FIG. 12, the mixer 140 can be installed on an aircraft having a nozzle 120 with a convergent duct portion 127 and a divergent duct portion 128, used to expand the exhaust stream to supersonic velocities, so long as the flow near the lobe mixers is subsonic. In still further embodiments, mixer configurations generally similar to those described above can be installed on subsonic aircraft, for example, aircraft having otherwise generally conventional turbofan engines with long duct mixed flow nozzles, as shown in FIG. 2. In any of these embodiments, the geometry of the nozzle positioned around and aft of the mixer can be fixed or variable, depending on the aircraft in which it is installed. The nozzle can have an axisymmetric shape (e.g., rotationally symmetric about the nozzle axis N), or a non-circular shape (e.g., square or rectangular), or another suitable shape.

Referring briefly again to FIG. 3, the overall “height” (or radial extent) of the forward-canted core lobes 142a is less than the overall “height” of the backward-canted core lobes 142b. This is because both the forward and backward canted core lobes 142a, 142b diverge from the neighboring fan lobes 143 by the same angle D, and have the same upper core lobe surface 142a. In other embodiments, the foregoing “heights” can be the same, e.g., by providing the forward-canted core lobes 142a with a larger divergence angle than the backward-canted lobes 142b. A representative arrangement is shown in FIG. 13, with both the forward and backward canted lobes 142a, 142b having the same overall height H, but with the first, forward canted core lobe 142a having a first divergence angle D1 that is larger than the corresponding second divergence angle D2 for the second, aft canted core lobe 142b.

From the foregoing, it will be appreciated that specific embodiments of the disclosed technology have been described herein for purposes of illustration, but that various modifications may be made without deviating from the technology. For example, the lobes described above can have shapes other than those explicitly shown in the Figures. Thus, for example, for rectangular nozzles with core and fan flow, the lobes may be positioned in two linear arrays, one on top of the other, with core lobes in the top array aligned with the core lobes or the fan lobes in the bottom array, rather than in a peripheral arrangement, and the lobe cant angles in each array can vary alternately as described above. The alternating arrangement of the lobes, in either round nozzles or rectangular nozzles, can be different, for example, two first core lobes can alternate with two second core lobes, or one second core lobe can be positioned between two pairs of first core lobes. The boundary between the core flow and the fan flow can be formed by a single wall (e.g., a single, shaped sheet), having opposing sides facing in opposite directions, or by multiple walls (e.g., two annularly-positioned sheets, supported relative to each other with spacers), each of which bounds a respective one of the core flow or the fan flow. The alternating arrangement of forward-canted and backward-canted lobes was described above in the context of core lobes. In other embodiments, the fan lobes can have alternating cant configurations, alone, and/or in combination with the alternating core lobes.

In still further embodiments, the extent to which different lobes are scalloped can vary from one lobe to the next, e.g., can vary from one lobe to its neighbor. This approach may further enhance vorticity, though in at least some embodiments, that enhancement may be offset by potential increases in total pressure loss and consequent decreases in thrust coefficient, and/or increases in manufacturing complexity. The cant angles, e.g., angles A and B described above with reference to FIGS. 3-4B, can be the same for both forward- and aft-canted lobes, or can vary. Representative cant angles are in the range of 10° to 20° in the forward direction (angle A in FIG. 4A), and 10° to 25° in the aft direction (angle B in FIG. 4B), In further particular embodiments, both angles A and B have values of from 10° to 15°. In still further embodiments, angles A and B can have other values. More generally, the dimensions, angles, and shapes described above can be altered in a variety of suitable manners that produce reduced or altered acoustic signatures at take-off, without significantly impacting thrust at cruise, depending on the engine operating conditions.

Certain aspects of the technology described in the context of particular embodiments may be combined or eliminated in other embodiments. Further, while advantages associated with certain embodiments of the disclosed technology have been described in the context of those embodiments, other embodiments may also exhibit such advantages, and not all embodiments need necessarily exhibit such advantages to fall within the scope of the present technology. Accordingly, the present disclosure and associated technology can encompass other embodiments not expressly shown or described herein.

As used herein, the term “and/or,” as in “A and/or B” refers to A alone, B alone, and both A and B. As used herein, the term “about” refers to values within 10% of the stated values.

The following examples provide additional representative features of the present technology.

### Examples

1. An aircraft lobed mixer nozzle, comprising:
a fan flow duct aligned along a longitudinal axis;
a core flow duct aligned along the longitudinal axis;
at least one duct wall forming, at least in part, a radially inner boundary of the fan flow duct, and a radially outer boundary of the core flow duct, with the duct wall terminating at a reference exit plane and having multiple first lobes extending radially inwardly, and multiple second lobes extending radially outwardly, and wherein at least one lobe is canted forward relative to the reference exit plane, and at least one lobe is canted aft relative to the reference exit plane.

2. The mixer nozzle of example 1 wherein the reference exit plane is normal to the longitudinal axis.

3. The mixer nozzle of example 1 wherein at least some of the lobes are scalloped.

4. The mixer nozzle of example 1 wherein neighboring lobes alternate between a forward cant and an aft cant.

5. The mixer nozzle of example 1 wherein the nozzle exit is axisymmetric.

6. The mixer nozzle of example 1 wherein the canted lobes are core lobes.

1. An aircraft lobed mixer nozzle, comprising:
a fan flow duct aligned along a longitudinal axis;
a core flow duct aligned along the longitudinal axis; and
at least one duct wall forming, at least in part, an inner boundary of the fan flow duct, and an outer boundary of the core flow duct, with the duct wall terminating at a reference exit plane and having multiple first lobes extending inwardly, and multiple second lobes extending outwardly, and wherein at least one lobe is canted forward relative to the reference exit plane, and at least one lobe is canted aft relative to the reference exit plane.

2. The mixer nozzle of claim 1 wherein the reference exit plane is normal to the longitudinal axis.

3. The mixer nozzle of claim 1 wherein at least some of the lobes are scalloped.

4. The mixer nozzle of claim 1 wherein neighboring lobes alternate between a forward cant and an aft cant.

5. The mixer nozzle of claim 1 wherein the at least one lobe includes one of the second lobes, positioned to direct core flow outwardly.

6. The mixer nozzle of claim 1 wherein the at least one lobe includes at least one of the first lobes, positioned to direct fan flow inwardly.

7. The mixer nozzle of claim 1 wherein the first lobes are fan lobes, the second lobes are core lobes, and the at least one lobe includes:
a first fan lobe and an adjacent first core lobe;
a second fan lobe and an adjacent second core lobe;
and wherein the first fan lobe diverges from the first core lobe at a first divergence angle, and the second fan lobe diverges from the second core lobe at a second divergence angle.

8. The mixer nozzle of claim 7 wherein the first and second divergence angles are not equal.

9. The mixer nozzle of claim 1 wherein the at least one lobe includes a lobe that is canted forward by a first angle and a lobe is canted aft by a second angle

10. The mixer nozzle of claim 9 wherein the first and second angles are the same.

11. The mixer nozzle of claim 9 wherein the first and second angles different.

12. The mixer nozzle of claim 1 wherein multiple second lobes include an alternating pattern of second lobes that are canted forward, and second lobes that are canted aft.

13. The mixer nozzle of claim 1, further comprising a nozzle duct positioned downstream of the first and second lobes.

14. The mixer nozzle of claim 13 wherein the nozzle duct is a convergent duct.

15. The mixer nozzle of claim 13 wherein the nozzle duct is a convergent/divergent duct.

16. The mixer nozzle of claim 13 wherein the nozzle duct has an axisymmetric cross-sectional shape.

17. The mixer nozzle of claim 13 wherein the nozzle duct has a non-axisymmetric cross-sectional shape.

18. An aircraft lobed mixer nozzle, comprising:
a fan flow duct aligned along a longitudinal axis;
a core flow duct aligned along the longitudinal axis;
at least one duct wall forming, at least in part, a radially inner boundary of the fan flow duct, and a radially outer boundary of the core flow duct, with the duct wall terminating at a reference exit plane and having multiple fan lobes extending radially inwardly to direct fan flow radially inwardly, and multiple core lobes extending radially outwardly to direct core flow radially outwardly, and wherein:
the core lobes and fan lobes include:
a first fan lobe and an adjacent first core lobe;
a second fan lobe and an adjacent second core lobe;
and wherein the first fan lobe diverges from the first core lobe at a first divergence angle, and the second fan lobe diverges from the second core lobe at a second divergence angle equal to the first divergence angle, and further wherein;
the core lobes alternate in a circumferential direction between a forward cant relative to the reference exit plane, and an aft cant relative to the reference exit plane.

19. The mixer nozzle of claim 18 wherein the reference exit plane is normal to the longitudinal axis.

20. The mixer nozzle of claim 18 wherein at least some of the lobes are scalloped.

21. An aircraft, comprising:
an airframe;
a pair of wings; and
a propulsion system, and wherein the propulsion system includes:
an engine;
an engine inlet positioned to direct air to the engine;
a lobed mixer nozzle positioned to receive exhaust from the engine, the lobed mixer nozzle including:
a fan flow duct aligned along a longitudinal axis;
a core flow duct aligned along the longitudinal axis; and
at least one duct wall forming, at least in part, a inner boundary of the fan flow duct, and a outer boundary of the core flow duct, with the duct wall terminating at a reference exit plane and having multiple first lobes extending inwardly, and multiple second lobes extending outwardly, and wherein at least one lobe is canted forward relative to the reference exit plane, and at least one lobe is canted aft relative to the reference exit plane.

22. The aircraft of claim 21 wherein the airframe, wings, and propulsion system are configured for supersonic cruise flight.

23. The aircraft of claim 21, further comprising a nozzle duct positioned downstream of the first and second lobes.

24. The aircraft of claim 23 wherein the nozzle duct is a convergent duct.

25. The aircraft of claim 23 wherein the nozzle duct is a convergent/divergent duct.

26. The mixer nozzle of claim 1 wherein:
the inner boundary is a radially inner boundary;
the outer boundary is a radially outer boundary;
the first lobes extend radially inwardly; and
the second lobes extend radially outwardly.

27. The aircraft of claim 21 wherein:
the inner boundary is a radially inner boundary;
the outer boundary is a radially outer boundary;
the first lobes extend radially inwardly; and
the second lobes extend radially outwardly.
